(19) United States
(12) Patent Application Publication
(10) Pub. No.: US 2026/0062328 A1
(43) Pub. Date: Mar. 5, 2026

(54) AUTOMATIC CHLORINE FEEDER FOR POOLS

(71) Applicants: Kevin Doyle, Pompano Beach, FL (US); Rakesh Reddy, Boca Raton, FL (US)

(72) Inventors: Kevin Doyle, Pompano Beach, FL (US); Rakesh Reddy, Boca Raton, FL (US)

(21) Appl. No.: 18/824,016

(22) Filed: Sep. 4, 2024

(51) Int. Cl. C02F 1/68; C02F 1/00; C02F 1/76; C02F 103/42

(52) U.S. Cl. CPC C02F 1/688; C02F 1/008; C02F 1/76; C02F 1/766; C02F 2103/42; C02F 2201/005; C02F 2201/009; C02F 2209/04; C02F 2209/29; C02F 2209/40; C02F 2303/04

(57) ABSTRACT

Examples herein include systems and methods for an improved disinfectant-dispensing device, such as a device that dispenses chlorine and/or bromine. An example embodiment can include a disinfectant-dispensing device with a chamber that holds solid disinfectant and includes an inlet and outlet. The device can also have a smart valve that includes an electric motor, a shaft, and a microcontroller. The electric motor can provide rotational motion to the shaft, which can extend or retract to allow or prevent the flow of water into the chamber. The microcontroller can operate the electric motor to control the shaft. The device can also include a battery that powers the electric motor and can be trickle charged via the low-power data channel. In one example, the microcontroller can receive a digital command from a pool controller on a low-power data channel and adjust the electric motor accordingly.

### BACKGROUND

Pools require appropriate levels of various chemicals in order to kill pathogens and maintain chemical balance. Pools are typically tested for some combination of pH, oxidation reduction potential (“ORP”), hardness, total alkalinity, salinity, stabilizer levels, and total and free chlorine and/or bromine. Appropriate chlorine or bromine levels are required to disinfect the water of a pool by killing bacteria and other microorganisms. Typically, the desirable range for free chlorine is about 1 to 3 parts per million while the desirable range for bromine is about 3 to 5 parts per million. Chlorine and bromine are collectively referred to herein as “disinfectants,” although for each of discussion, the term “chlorine” can be understood to also include bromine herein.

When the disinfectant level of a pool drops below the desired range, chlorine and/or bromine can be added by introducing tablets, granules, or liquid to the pool. While so-called “automatic” feeders exist on the market, they have various drawbacks. For example, a typical design for such a feeder includes a chamber with tablets or pellets, along with a flow path that circulates water through the chamber before sending it to the pool. The water absorbs some amount of the disinfectant and delivers it to the pool in that manner. These feeders can also include a valve for manually adjusting the fluid-flow rate through the feeder, with a faster flow delivering relatively more disinfectant to the pool.

These feeders have various drawbacks. For example, because existing feeders include manual flow controls, they typically operate at a particular rate until the next adjustment is made. During this time, the pool's disinfectant demand can fluctuate based on various factors. For example, changes in sunlight, pool temperature, rainfall, or usage can cause the pool's disinfectant demand to change. When the demand changes but the rate of disinfectant addition remains steady, the pool can become unbalanced.

Another drawback to existing feeders is that the chlorination they provide varies based on the volume and surface area of the solid medium inside the feeder. For example, a user may fill the feeder completely with chlorine pellets, resulting in maximum chlorination when water is fed through. But as these pellets erode over time, the chlorination level drops even with the same flow rate. This means that the feeder is not able to provide a constant level of chlorination.

Finally, existing feeders are unable to be controlled by pool-automation equipment and cannot make use of feedback from sensors indicating the state of the pool. For example, an existing feeder would be unaware of the current chlorine levels within the pool or the rate at which the feeder itself is adding chlorine. This results in additional manual intervention in order to properly control the disinfectant levels of the pool.

As a result, a need exists for an improved chlorine feeder that can automatically control the amount of chlorine dispensed to a pool, can communicate with pool-automation equipment, and can receive feedback from sensors and adjust chlorine dispensing accordingly.

### SUMMARY

Examples described herein include systems and methods for an improved disinfectant-dispensing device, such as a device that dispenses chlorine and/or bromine. The device can be easily integrated into a pool system and is highly responsive to digital commands and pool conditions.

An example embodiment can include a disinfectant-dispensing device with an inlet to receive flowing water and an outlet to dispense flowing water. The device may have a chamber that can hold solid disinfectant, such as chlorine or bromine, and the chamber can be in fluid connection with the inlet and the outlet. The device can also have a smart valve that includes an electric motor, a shaft, and a microcontroller. The electric motor can provide rotational motion to the shaft, which can extend or retract to allow or prevent the flow of water into the chamber. In an example, the shaft can be positioned to prevent the flow of water when fully extended and positioned to allow the full flow of water when retracted beyond a certain point. The microcontroller can operate the electric motor to control the opening and closing of the smart valve.

In one implementation, the microcontroller can receive a digital command from a pool controller on a low-power data channel. This allows the device to be easily controlled and integrated into existing pool systems. The device can also include a battery that powers the electric motor and can be trickle charged via the low-power data channel.

The shaft of the smart valve is positioned to extend into a flow channel that draws water from the inlet based on a venturi flow effect. This provides an efficient way to mix the disinfectant with the pool water in a controlled manner and ensure that it is evenly distributed throughout the pool.

The microcontroller can adjust the position of the shaft based on a disinfectant level measured for the pool. This allows the device to maintain an optimal level of disinfection in the pool water at all times. Additionally, the microcontroller can generate an alert when a target disinfectant level for the pool cannot be achieved. This ensures that any issues with the pool's disinfection system, such as a lack of sufficient disinfection medium within the device, can be quickly addressed.

The disinfectant-dispensing device can thereby provide efficient and effective disinfection of pool water, while also being highly responsive to digital commands and pool conditions.

In another example, a smart valve is provided for controlling the dispensing of disinfectant. An example smart valve can include a housing that can be mounted to a disinfectant-dispensing device, an electric motor within the housing, and a shaft coupled to the electric motor. The smart valve also includes a microcontroller that can operate the electric motor. When the housing is mounted to the disinfectant-dispensing device and the shaft is in a fully extended position, the shaft can prevent the flow of water through the disinfectant-dispensing device. Similarly, when the shaft is in a fully retracted position, the shaft can allow for the flow of water through the dispensing device. The shaft can be adjusted in small increments to achieve a desired flow rate through the dispensing device.

In an example, the microcontroller can be configured to receive a digital command from a pool controller, which can be received on a low-power data channel. In addition, the smart valve can include a battery that can be configured to power the electric motor and be trickle charged via a low-power data channel. The shaft can be positioned such that it extends into a flow channel of the disinfectant-dispensing device when the housing is mounted to the disinfectant-dispensing device, and the flow channel can draw water from the inlet based on a venturi flow effect. Furthermore, the microcontroller can adjust the position of the shaft based on a disinfectant level measured for the pool and can generate an alert when a target disinfectant level for the pool cannot be achieved.

Similarly, an example method can include mounting a smart valve to a disinfectant-dispensing device. The smart valve includes an electric motor, a shaft, and a microcontroller. The shaft is coupled to the electric motor, and its position can be modified by engaging the motor. When the smart valve is mounted to the disinfectant-dispensing device and the shaft is in a fully extended position, the shaft prevents the flow of water through the disinfectant-dispensing device. Similarly, when the shaft is in a fully retracted position, the shaft can allow for the flow of water through the dispensing device.

The example method can also include providing an instruction to the microcontroller to modify the position of the shaft by engaging the electric motor, thus controlling the dispensing of disinfectant into the pool. In some examples, the method can also include receiving an alert from the microcontroller if the disinfectant concentration level of the pool cannot be brought into a target concentration range. This can indicate that the solid disinfectants within the dispensing device have eroded or dissolved to the point that more solids should be added to the device.

The examples summarized above can each be incorporated into a non-transitory, computer-readable medium having instructions that, when executed by a processor associated with an acid-dispensing device, cause the processor to perform the stages described. Additionally, an acid-dispensing system is disclosed which is configured to perform one or more of the methods disclosed herein.

Both the foregoing general description and the following detailed description are exemplary and explanatory only and are not restrictive of the examples, as claimed.

### BRIEF DESCRIPTION OF THE DRAWINGS

FIG. 1 is a perspective view of an example disinfectant-dispensing device including a smart valve according to one or more embodiments herein.

FIG. 2 is a cross-sectional view of an example disinfectant-dispensing device including a smart valve according to one or more embodiments herein.

FIG. 3 is a cross-sectional view of an example smart valve according to one or more embodiments herein.

FIG. 4 is a schematic of a system for dispensing disinfectant from a disinfectant-dispensing device to a pool utilizing a low-power data channel.

FIG. 5 is a flowchart of an example method for using a smart valve to dispense disinfectant to a pool and monitor disinfectant levels thereof.

### DESCRIPTION OF THE EXAMPLES

Reference will now be made in detail to the present examples, including examples illustrated in the accompanying drawings.

Examples herein include systems and methods for an improved disinfectant-dispensing device, such as a device that dispenses chlorine and/or bromine. An example embodiment can include a disinfectant-dispensing device with a chamber that holds solid disinfectant and includes an inlet and outlet. The device can also have a smart valve that includes an electric motor, a shaft, and a microcontroller. The electric motor can provide rotational motion to the shaft, which can extend or retract to allow or prevent the flow of water into the chamber. The microcontroller can operate the electric motor to control the shaft. The device can also include a battery that powers the electric motor and can be trickle charged via the low-power data channel. In one example, the microcontroller can receive a digital command from a pool controller on a low-power data channel and adjust the electric motor accordingly.

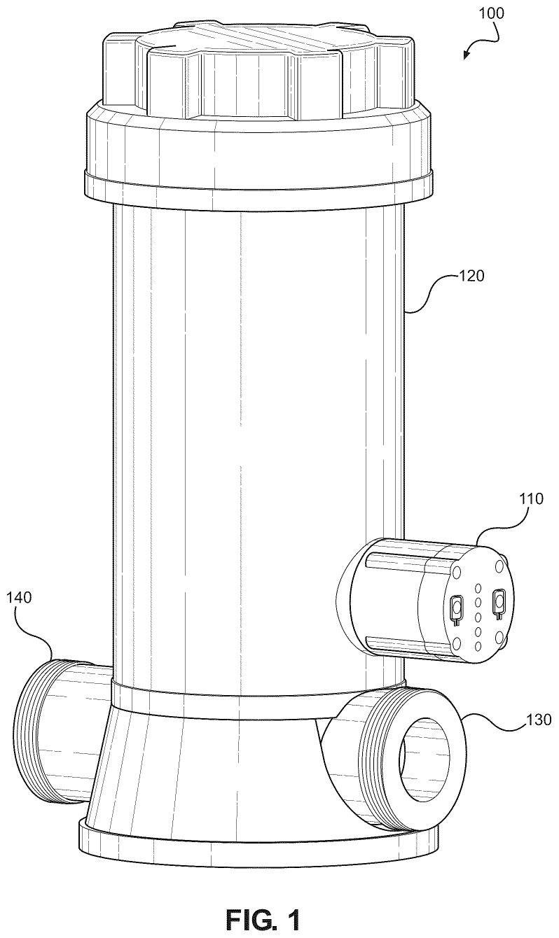

FIG. 1 is a perspective view of an example disinfectant-dispensing device 100. The disinfectant-dispensing device 100 can be configured to dispense any type of disinfectant, such as chlorine, or bromine, or any other disinfectant, into a fluid strea. The fluid stream can then be directed to a pool, spa, or any other body of water.

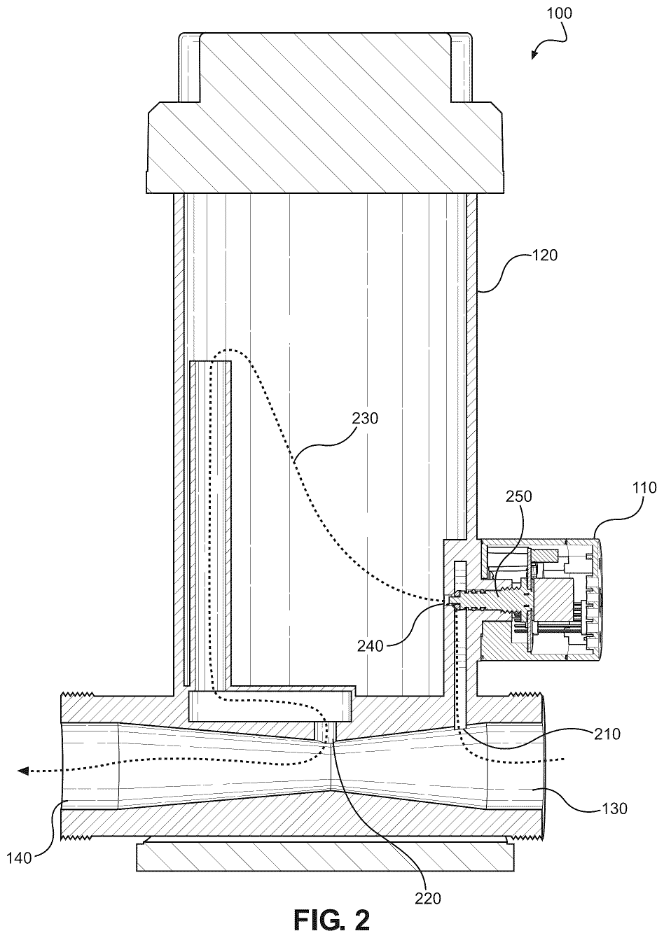

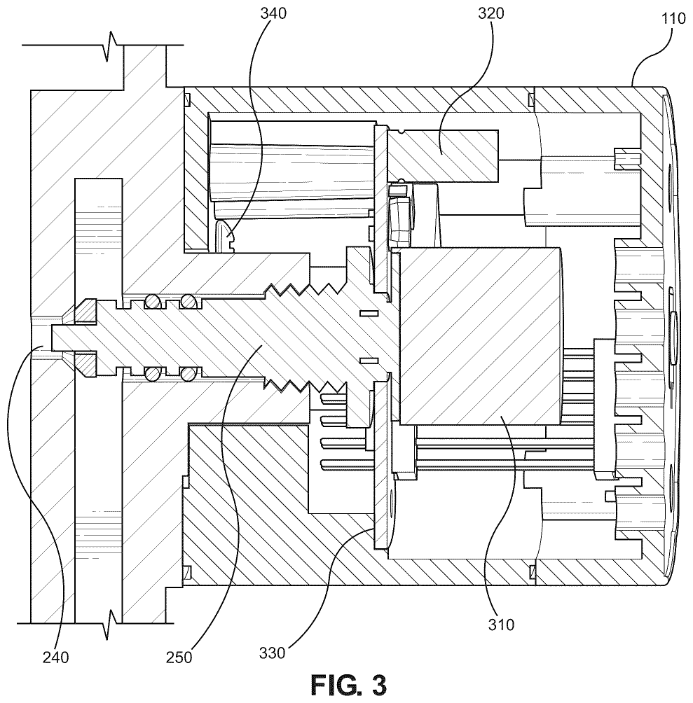

The disinfectant-dispensing device 100 can include a smart valve 110. As explained in more detail below, the smart valve 110 can control the flow of water through a chamber 120 or body portion of the disinfectant-dispensing device 100. The chamber 120 can house disinfectant medium, such as solid chlorine or bromine. When water flows through the chamber 120, it dissolves some of the solid disinfectant and transports it to the pool or spa. In particular, water can enter the disinfectant-dispensing device 100 through an inlet 130 and exit the disinfectant-dispensing device 100 through an outlet 140. In some examples, the inlet and outlet are installed in-line with a main water line associated with a pool or spa. This eliminates the need for redirecting the flow through an ancillary pipe system that is dedicated to the disinfectant-dispensing device 100, reducing the costs for installing the device 100. The smart valve 110 is discussed in more detail with respect to FIGS. 2 and 3 below.

FIG. 2 provides a cross-sectional view of the disinfectant-dispensing device 100 of FIG. 1. In the example of FIG. 2, the disinfectant-dispensing device 100 is configured to utilize the venturi effect to circulate water within the chamber 120. Generally speaking, the venturi effect is a phenomenon where a fluid passing through a constricted section of a pipe experiences an increase in velocity and a corresponding decrease in pressure. In a chlorine feeder, a small diameter pipe or tubing is used to inject chlorine into the water flow. The pipe is placed in the path of the water flow and contains a restriction, such as a narrow orifice or a venturi valve. As water flows through the restriction, its velocity increases and its pressure decreases, creating a suction effect that draws chlorine into the pipe.

The example disinfectant-dispensing device 100 of FIG. 2 utilizes a similar effect. For example, the inlet 130 and outlet 140 are approximately the same diameter as shown, but a throat portion in the center is narrower and therefore a constricted section of pipe. Toward the larger-diameter portion of the pipe, such as near the inlet in this example, a venturi inlet 210 is depicted. The venturi inlet 210 can be an aperture or pipe in fluid connection with the inlet 130 as shown.

Similarly, the disinfectant-dispensing device 100 of FIG. 2 includes a venturi outlet 220, which can be an aperture or pipe in fluid connection with the throat area of the main flow line, as shown. The constricted throat area of the flow line causes relatively higher velocity and lower pressure flow than the inlet area 130 of the flow line. This means that the venturi inlet 210 remains in fluid communication with higher pressure fluid relative to the venturi outlet. Thus, the venturi tunnel tends to induce fluid flow through the chamber from the venturi inlet 210 to the venturi outlet 220. This flow path is shown by element 230.

The venturi inlet 210 is in fluid communication with the chamber 120 by way of a valve inlet 240. The valve inlet, which is discussed in more detail with respect to FIG. 3, provides a control point where the smart valve 110 can influence the flow into the chamber 120. Specifically, the smart valve 110 can include a shaft 250 that extends and retracts to close or open the valve inlet 240, respectively.

FIG. 3 provides a cross-sectional view of the smart valve 110 shown in FIGS. 1 and 2. This view shows the valve inlet 240, which in this example configuration is slightly open. The drawing also shows the shaft 250 that controls the opening associated with the valve inlet 240. The shaft 250 can any mechanical device that can be moved to open and close the valve inlet 240. In this particular example, the shaft 250 includes a threaded rod that extends or retracts based on the rotational interaction of the threads along at least a portion of the rod.

However, this disclosure is not limited to a threaded rod or to a particular type of mechanism for closing the valve inlet 240. For example, the shaft 250 can be driven by one or more gears or cams that cause the shaft 250 to extend and retract. In another example, the shaft 250 can be driven by a hydraulic actuator of appropriate scale. Regardless of the type of mechanism used, the shaft 250 can be driven via an electric motor 310. The electric motor 310 provides a rotational output that can be mechanically coupled to the shaft 250 such that the shaft 250 extends and retracts to close or open the valve inlet 240, respectively.

The electric motor 310 can be driven based on electricity stored at a battery 320 within the smart valve 110 body. While in some embodiments the electric motor 310 can additionally or alternatively be driven using a direct AC or DC connection, battery power can provide a more flexible arrangement. For example, the battery 320 can be trickle charged when necessary to retain an appropriate charge level. The electric motor 310 does not require much power—for example, it generally needs to make only small adjustments to the shaft 250 to appropriately control the flow rate into the chamber 120. As a result, the electric motor 310 can be powered from the battery 320, leaving sufficient time for the battery 320 to trickle charge in between uses to retain sufficient charge.

In some examples, the battery 320 can be charged through a low-power data channel, such as a communication bus. An example low-power data channel can be a channel that utilizes an electrical signaling standard such as RS-485 (also known as TIA-485 or EIA-485), in an example. The smart valve 110 can draw power through the data channel. In some examples, the device can use a current limiting system to cap the current draw. For example, the device can include a current limiter that limits the current draw to 20 mA or 25 mA, or any other level suitable for the power source. In some examples, the power source is a controller operating according to one or more electrical standards that limit current draw.

The smart valve 110 can use the current draw to charge the battery 320. Although the current draw can be low, such as 20 mA or 25 mA, this draw is sufficient to trickle charge a battery such as a lithium-ion battery. The battery can then be used later to discharge larger power levels for short periods of times, trickle charging when necessary to retain an acceptable level of charge. For example, the smart valve 110 can draw current from the data channel whenever the battery charge level is below a threshold level, such as 80%, 90%, 99%, or any other charge level.

Although various examples herein describe the use of a battery, such as a lithium-ion battery, other energy storage techniques can be used as well. For example, electricity can be stored in a capacitor, such as a supercapacitor, that can store and discharge energy on command. Some or all of these components can be located on a circuit board 330, which can include various other components. For example, the circuit board 330 can include a microprocessor that receives and sends signals and can interpret and execute commands. In one example, the microprocessor can receive a signal that includes a command to open the valve inlet 240, such as a command to open the valve inlet 240 to a 50% flowrate position. The microprocessor can interpret this command and instruct the motor 310 to operate in a particular direction for a particular amount of time and/or for a particular number of rotations. The example of a 50% flowrate position is exemplary only, and any other percentage can be used to open the valve inlet 240 to a desired amount.

The smart valve 110 of FIG. 3 also includes various mounting hardware, including the mounting hardware 340 shown in the drawing. The mounting hardware 340 can include one or more screws, bolts, or other fasteners. The mounting hardware 340 can also include a mounting plate that can be internal to the smart valve 110 or can be provided as a separate plate that mounts to the disinfectant-dispensing device 100 before installation of the smart valve 100.

Additionally, the smart valve 110 can utilize one or more sensors in order to detect the position of the shaft. In one example, the smart valve 110 includes a magnetic sensor (i.e., a sensor utilizing the hall effect). An example magnetic sensor can include a thin strip of a semiconductor material that has a current flowing through it. When a magnetic field is applied perpendicular to the current flow, it creates a voltage across the semiconductor material, which can be measured and used to determine the strength of the magnetic field. By analyzing the signal from a magnetic sensor placed near the valve inlet 240 side of the shaft 250, the smart valve 110 can determine the position and rotation speed of the shaft 250. This information can then be used in a feedback loop to position the shaft 250 as needed for the current demands of the pool or spa.

In another example, the smart valve 110 uses an optical sensor to determine the position and/or rotation speed of the shaft 250. An example optical sensor can include two disks, one fixed to the shaft 250 and the other attached to a stationary surface or the smart valve 110.

The disk attached to the shaft can include a series of opaque and transparent segments arranged in a circular pattern, while the stationary disk has an optical sensor (such as a photodiode) that detects the light that passes through the transparent segments of the rotating disk. As the shaft rotates, the light passing through the transparent segments of the rotating disk will be detected by the sensor on the stationary disk, and the sensor will output a series of pulses, indicating the position and speed of the shaft 250. This information can then be used in a feedback loop to position the shaft 250 as needed for the current demands of the pool or spa.

In another example, the smart valve 110 uses a capacitive sensor to determine the position and/or rotation speed of the shaft 250. An example capacitive sensor can include two conductive plates separated by a dielectric material. When a voltage is applied to one of the plates, an electric field is created between the two plates. The capacitance between the plates changes when an object is brought close to the sensor, due to the interaction between the object and the electric field. To use a capacitive sensor to determine the position of the shaft 250, the sensor is placed near the shaft 250 and the two are arranged such that the distance between them varies as the shaft 250 rotates. As the shaft 250 rotates, the distance between the shaft 250 and the sensor changes, altering the capacitance of the sensor. This change in capacitance can be detected and used to determine the position and speed of the shaft 250. In another example, the smart valve 110 can determine the position of the shaft 250 without using any of the sensors listed above. For example, the shaft 250 can be moved to its further position in either direction to determine a starting position. As an example, the shaft 250 can be extended until it physically contacts the valve inlet 240 such that no further extension of the shaft 250 is possible. This provides a starting position for the shaft 250 where the valve inlet 240 is completely blocked. Similarly, the shaft 250 can be moved the other direction until no further movement is possible, indicating a fully open position for the shaft 250.

While not shown in the drawings, the smart valve 110 can also include physical buttons, switches, or dials that allow for manual control. Using these physical controls, a user can set intensity (i.e., valve inlet 240 opening size) as well as a duration of time for that setting, including making it a permanent setting until otherwise changed by the user. To assist in communicating information to a user in physical proximity of the smart valve 110, the device can also include one or more lights indicating various information about the smart valve 110. For example, the lights can communicate a battery charge level, estimated level of disinfectant material, intensity, and the presence of any alerts. This information can also be provided on a user interface, such as in an application associated with the smart valve 110.

The smart valve 110 can also make use of information derived from additional sensors, either internal or external to the smart valve 110 itself. For example, the smart valve 110 can include an ORP sensor or receive information from an external ORP sensor. The information can indicate a recent ORP reading for the water in the system. This indication can be used as feedback to adjust the disinfectant dispensing accordingly.

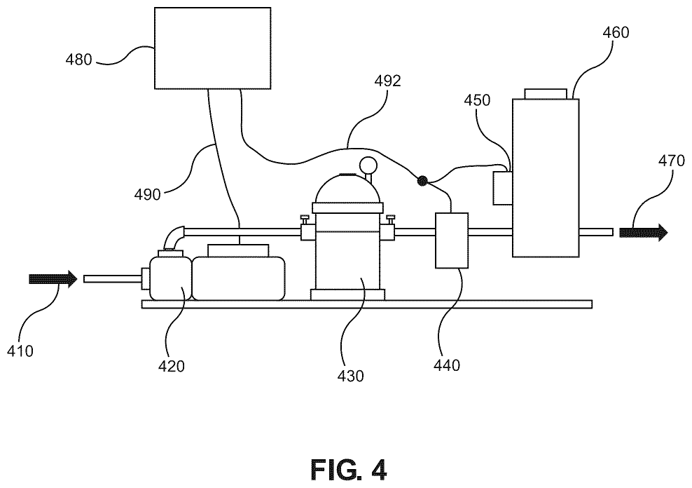

FIG. 4 provides an illustration of an example system for dispensing disinfectant from a disinfectant-dispensing device to a pool utilizing a low-power data channel. The system of FIG. 4 shows incoming water flow 410, which is a fluid mixture from the pool or spa. After being treated by the various components shown in FIG. 4, and potentially other components not shown here, the outgoing water flow 470 is returned to the pool or spa. The outgoing water flow 470 is treated with, among other things, appropriate levels of disinfectant.

The incoming water flow 410 is pulled into the system via a pool pump 420. The pump can be controlled by a control system 480, which can send a control signal via channel 490 to the pump 420 to instruct it to turn on or off, or to run at a particular rate. The water then flows through a filter 430 that filters particles and contaminants from the water. The filtered water then flows through a chemistry measurement device 440. In some examples, the chemistry measurement device 440 measures at least one of pH, oxidation-reduction potential (“ORP”), and any other relevant chemistry measurements. In some examples, the chemistry measurement device 440 measures a disinfectant level such as a level of chlorine or bromine in the water.

The chemistry measurement device 440 can communicate with the control system 480 via a low-power data channel 492. For example, the chemistry measurement device 440 can send measurement information to the control system 480 by sending one or more digital signals on the data channel 492. The control system 480 can utilize this information to determine whether any adjustments to the system are required.

For example, the control system 480 can send a signal on the data channel 161 to a disinfectant-dispensing device 460, through which the water flows after exiting the chemistry measurement device 440. In an example where the control system 480 determines that the level of chlorine and/or bromine measured by the chemistry measurement device 440 is outside of an optimal range, the control system 480 can instruct the disinfectant-dispensing device 460 to make an adjustment. Continuing the example, if the measured level of disinfectant is below the allowed range, then the control system 480 can instruct the disinfectant-dispensing device 460 to increase its level of dispensing. Similarly, if the measured level of disinfectant is above the allowed range, then the control system 480 can instruct the disinfectant-dispensing device 460 to decrease its level of dispensing.

The control system 480 can provide instructions to the disinfectant-dispensing device 460 by communicating with the smart valve 450, which can be the same smart valve described above with respect to FIGS. 1-3. In some examples, the control system 480 can calculate a particular adjustment required to reach the desired range of disinfectant levels in the water. As an example, the control system 480 can determine that the disinfectant level is only marginally below the desired range, and as a result can instruct the disinfectant-dispensing device 460 to open the valve inlet 240 by 10%. In another example where the control system 480 determines that the disinfectant level is well below the desired range, it can instruct the disinfectant-dispensing device 460 to open the valve inlet 240 to 100% open.

Although the control system 480 can determine the appropriate changes to the disinfectant-dispensing device 460 in some examples, in other examples the disinfectant-dispensing device 460 itself can make these determinations. For example, the control system 480 can simply provide one or more measurements from the chemistry measurement device 440 to the smart valve 450. In that example, the smart valve 450 can determine what changes, if any, are necessary to maintain the water within an acceptable range of disinfectant concentration.

The smart valve 450 can store previous readings and adjustments in order to generate a feedback loop from the measured disinfectant levels. As an example, the smart valve 450 can receive an indication that the disinfectant levels are below the target range, and in response opens the valve inlet 240 to 100% open. In addition, rather than altering only the valve inlet 240 opening, the smart valve 450 can also increase the run time such that the valve inlet 240 remains open for a longer period of time than previously. After some period of time, such as one hour, the smart valve 450 can receive another indication that the disinfectant levels remain below the target range. The smart valve 450 can compare the current level to the previous level to determine whether the level is increasing at a sufficient rate to reach the desired target range within a predetermined amount of time. If the comparison does not indicate that the target range will be reached-for example where the current disinfectant level is equal to or less than the previous reading, even with the valve inlet 240 fully open-then the smart valve 450 can determine that the disinfectant-dispensing device 460 does not have sufficient disinfectant material in the chamber 120.

In examples where the smart valve 450 determines that the device 460 lacks sufficient disinfectant material, the smart valve 450 can generate an alert. The alert can be generated in the form of a signal sent to the control system 480 via the data channel 492, for example. The control system 480 can then send a notification to a user indicating that the disinfectant-dispensing device 460 requires more disinfectant material. The notification can be sent before the disinfectant material is completely depleted, providing a warning that the device is almost empty and that the user should add more material. In some examples, the disinfectant-dispensing device 460 can generate and send the notification. In yet other examples, the control system 480 can perform any or all of the calculations and determinations described above with respect to the disinfectant-dispensing device 460.

In this way, a user will be quickly alerted to situations where the disinfectant-dispensing device 460 lacks the proper level of disinfectant. And once the user refills the device 460, the smart valve 450 will adjust to the suddenly higher concentrations by receiving feedback and adjusting the valve inlet 240 accordingly to maintain appropriate chemical levels in the pool or spa.

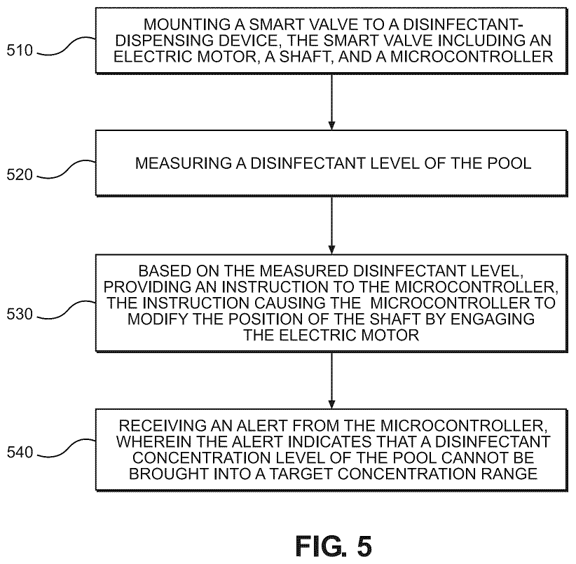

FIG. 5 provides a flowchart of an example method for using a smart valve to dispense disinfectant to a pool or spa and monitor disinfectant levels thereof. Stage 510 of the example method can include mounting a smart valve to a disinfectant-dispensing device. For clarity, this can include manufacturing a disinfectant-dispensing device that includes a smart valve, but it can also include modifying an existing disinfectant-dispensing device to replace a conventional valve with a smart valve.

The smart valve can be mounted to the disinfectant-dispensing device using mechanical fasteners such as screws or bolts. In some examples, the smart valve includes a screw or bolt pattern that matches the pattern used for conventional valves, such that the smart valve can be mounted in the same location with minimal modifications. In some examples, the mounting hardware from the conventional valve can be used to mount the smart valve. The smart valve can include an electric motor, a shaft, and a microcontroller as described above with respect to FIGS. 2 and 3.

At stage 520, a chemistry measurement device can measure a disinfectant level of the pool. This can be performed by testing water as it flows through the pool control system, such as explained with respect to FIG. 4. The measured disinfectant level can be provided to the control system of the pool, the smart valve, or both, as part of this stage.

Stage 530 can include, based on the measured disinfectant level, providing an instruction to the microcontroller. The instruction can be generated by the control system of the pool in some examples, while in other examples the instruction can be generated by the microcontroller itself. In either case, the instruction causes the microcontroller to modify the position of the shaft by engaging the electric motor. In some examples, the motor is engaged for a set amount of time, such as 2 seconds, in order to open the valve inlet a predetermined amount. This stage can include opening or closing the valve inlet in any increment.

Stage 540 can include receiving an alert from the microcontroller. The alert can indicate that a disinfectant concentration level of the pool cannot be brought into a target concentration range

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A disinfectant-dispensing device, comprising:
an inlet configured to receive flowing water into the device;
an outlet configured to dispense flowing water from the device;
a chamber configured to hold solid disinfectant, wherein the chamber is in fluid connection with the inlet and the outlet;
a smart valve mounted on the disinfectant-dispensing device, wherein the smart valve comprises:
an electric motor that provides rotational motion;
a shaft coupled to the electric motor, such that operation of the electric motor causes the shaft to extend or retract, wherein the shaft is positioned such that, in a fully extended position, the shaft prevents the flow of water into the chamber; and
a microcontroller that operates the electric motor.

2. The disinfectant-dispensing device of claim 1, wherein the microcontroller is configured to receive a digital command on a low-power data channel from a pool controller.

3. The disinfectant-dispensing device of claim 1, wherein the microcontroller operates the electric motor based on feedback indicating an oxidation-reduction-potential level of the flowing water.

4. The disinfectant-dispensing device of claim 1, further comprising a battery configured to power the electric motor.

5. The disinfectant-dispensing device of claim 4, wherein the battery is configured to be trickle charged via a low-power data channel.

6. The disinfectant-dispensing device of claim 1, wherein the shaft is positioned such that it extends into a flow channel.

7. The disinfectant-dispensing device of claim 6, wherein the flow channel draws water from the inlet based on a venturi flow effect.

8. The disinfectant-dispensing device of claim 1, wherein the microcontroller adjusts the position of the shaft based on a disinfectant level measured for the pool.

9. The disinfectant-dispensing device of claim 1, wherein the microcontroller generates an alert when a target disinfectant level for the pool cannot be achieved.

10. A smart valve for controlling the dispensing of disinfectant, comprising:
a housing with at least one mounting point for mounting the smart valve to a disinfectant-dispensing device;
an electric motor within the housing that provides rotational motion;
a shaft coupled to the electric motor, such that operation of the electric motor causes the shaft to extend or retract, wherein the shaft is positioned such that, when the housing is mounted to the disinfectant-dispensing device and the shaft is in a fully extended position, the shaft prevents the flow of water through the disinfectant-dispensing device; and
a microcontroller that operates the electric motor.

11. The smart valve of claim 10, wherein the microcontroller is configured to receive a digital command on a low-power data channel from a pool controller.

12. The smart valve of claim 10, wherein the microcontroller operates the electric motor based on feedback indicating an oxidation-reduction-potential level of the flowing water.

13. The smart valve of claim 10, further comprising a battery configured to power the electric motor.

14. The smart valve of claim 13, wherein the battery is configured to be trickle charged via a low-power data channel.

15. The smart valve of claim 10, wherein the shaft is positioned such that it extends into a flow channel of the disinfectant-dispensing device when the housing is mounted to the disinfectant-dispensing device.

16. The smart valve of claim 15, wherein the flow channel draws water from the inlet based on a venturi flow effect.

17. The smart valve of claim 10, wherein the microcontroller adjusts the position of the shaft based on a disinfectant level measured for the pool.

18. The smart valve of claim 10, wherein the microcontroller generates an alert when a target disinfectant level for the pool cannot be achieved.

19. A method for controlling the dispensing of disinfectant into a pool, comprising:
mounting a smart valve to a disinfectant-dispensing device, the smart valve including:
an electric motor within the housing that provides rotational motion;
a shaft coupled to the electric motor, such that operation of the electric motor causes the shaft to extend or retract, wherein the shaft is positioned such that, when the smart valve is mounted to the disinfectant-dispensing device and the shaft is in a fully extended position, the shaft prevents the flow of water through the disinfectant-dispensing device; and
a microcontroller that operates the electric motor;
measuring a disinfectant level of the pool; and
based on the measured disinfectant level, providing an instruction to the microcontroller, the instruction causing the microcontroller to modify the position of the shaft by engaging the electric motor.

20. The method of claim 19, further comprising receiving an alert from the microcontroller, wherein the alert indicates that a disinfectant concentration level of the pool cannot be brought into a target concentration range.
